(19) United States
(12) Patent Application Publication
(10) Pub. No.: US 2014/0379531 A1
(43) Pub. Date: Dec. 25, 2014

(54) METHOD FOR COLLECTING SALES AND USE TAX IN REAL-TIME

(71) Applicant: INTEGRATED DIRECT MANAGEMENT TAXATION SERVICES, L.L.C., Sandy, UT (US)

(72) Inventors: George Huang, Rancho Cucamonga, CA (US); John Gibson, Rancho Cucamonga, CA (US); Mustafa Mark Noorzai, Moorpark, CA (US)

(73) Assignee: INTEGRATED DIRECT MANAGEMENT TAXATION SERVICES, L.L.C., Sandy, UT (US)

(21) Appl. No.: 14/311,563

(22) Filed: Jun. 23, 2014

Related U.S. Application Data
(60) Provisional application No. 61/839,025, filed on Jun. 25, 2013.
(60) Provisional application No. 61/933,315, filed on Jan. 30, 2014.
(60) Provisional application No. 61/863,906, filed on Aug. 9, 2013.
(60) Provisional application No. 61/937,484, filed on Feb. 8, 2014.

(51) Int. Cl. G06Q 40/00; G06Q 30/06

(52) U.S. Cl. CPC G06Q 40/10; G06Q 30/0635
USPC 705/26.81; 705/30

(57) ABSTRACT

A system and method for collection of tax in real time from customers conducting a remote, non-in-store purchase. The system comprises a merchant shopping cart subsystem, tax calculation service, and a charging, archival, and reporting system (CARS) subsystem. Participating merchants in the system do not conduct tax calculations and will not receive tax revenue payments, and thus will not be required to maintain and provide reports to tax authorities. Tax revenue on customer purchases from merchants participating in the system will be collected by a third party authorized by the respective participating tax authority. The collected tax revenue will be held by the third party in a trust account until such time as the tax authority request the revenue.

### CROSS REFERENCE TO RELATED APPLICATIONS

This application claims the benefit of: 1) provisional patent application bearing Ser. No. 61/839,025 filed Jun. 25, 2013; 2) provisional patent application bearing Ser. No. 61/863,906 filed Aug. 9, 2013; 3) provisional patent application bearing Ser. No. 61/933,315 filed Jan. 30, 2014; and, 4) provisional patent application bearing Ser. No. 61/937,484 filed Feb. 8, 2014; the contents of which are hereby incorporated by reference herein in their entirety for all purposes.

### FIELD OF THE INVENTION

The present invention pertains to retail commerce, and more specifically, to transaction processing.

### BACKGROUND OF THE INVENTION

In most jurisdictions, consumers are taxed for their consumption of most goods and services. Most often, the taxes are collected by the sellers because of the ease of collection; from hundreds of thousands of sellers instead of hundreds of millions of consumers. When tax is collected at the point-of-sale (POS) which is defined as the consumer and merchant having a presence in the same tax jurisdiction, it is termed a sales tax. Sales tax, in effect, is the tax being collected by the retailers or merchants on behalf of the government because of the convenience factor for the government. By doing business within the State, the retailer is required by law to collect the tax. This is not the case for on-line retailers not having a presence within the particular State.

Oftentimes, tax is not collected when a purchase occurs on-line and across state lines. Many State governments categorize this instead as a “use tax” and place the responsibility for reporting and payment upon the consumer rather than the retailer or merchant.

Physical stores enjoy a fairly straightforward procedure for collection of sales tax. Because POS occurs within a particular State, calculation of the applicable tax typically requires compliance with one state tax authority and one tax rate based on the location of the store. The tax formulas are programmed into retailer's POS systems to handle the sales tax calculations.

Tax calculations, are more complex when the retailer and customer reside in different state jurisdictions. Due to the difficulty for out-of-state retailers to comply with up to 50 State tax authorities, retailers not having a physical presence in the State were exempted from sales tax collection in the United States Supreme Court decision Quill vs. North Dakota, 504 U.S. 298 (1992). States have no easy means to identify unpaid use taxes and therefore rarely bother with a collection effort. With Internet sales increasing as a percentage of total retail sales, states are losing more tax revenue each year. Meanwhile, local stores which collect the sales taxes operate at a disadvantage since the tax they are obligated to collect can account for the overall purchase price being 5-10% higher than on-line retailers.

U.S. Pat. No. 8,700,504 issued to Barsade provides a detailed background into varied methods contemplated to identify, report and remit sales tax. Implementation of these methods has proven difficult since the tax reporting and mandatory payment obligations imposed on the merchant are significant. U.S. Pat. No. 8,583,518 issued to Luongo describes a POS system in which an approval for the price of the transaction and tax occurs and the revenue attributed to the sales transaction is settled in favor of a first account and the tax portion is settled in favor of a second account that is different from the first account. Luongo thus imposes responsibility on the transaction card processor to deposit the correct amount of tax into the second account; a responsibility for which the transaction card processor may be unwilling to accept. (The teachings of the proceeding U.S. patents are hereby incorporated by reference.)

With no effective method to report use tax information, purchased digital goods provide unscrupulous merchants with an advantage over physical versions of the identical items (e.g., a CD or boxed software) if they were to underreport the actual level of sales to the distributor or participate in copyright infringement.

Accordingly, there is a need on the part of state governments to be able to accurately and efficiently collect use tax as easily as POS sales tax without retailers or merchants being burdened with regulatory compliance requirements from multiple state tax authorities.

On-line sales/use tax collection would solve a major tax non-compliance issue, increase revenue to state and local governments and reduce the pressure for new taxes on other items. In addition, taxing on-line purchases will level the playing field with in-state brick-and-mortar retail establishments, and help protect local jobs and income.

There is also a need for accurate collection and reporting of information which will eliminate on-line piracy and ensure that legitimate distributors and royalty owners receive their just compensation.

### SUMMARY OF THE INVENTION

A real-time online sales/use tax collection system (the “SYSTEM”) is presented for the purchase of physical and tangible goods, non-physical (digital and intangible) goods, and services online and through other remote venues.

Also described is an optional accounting method by which legitimate distributors and royalty owners will receive revenue and on-line piracy can be virtually eliminated. Both systems operate on modified versions of a Charging, Archival, and Reporting System (CARS) subsystem which will be described in detail below.

A key feature of the SYSTEM is relieving merchants of any responsibility to collect tax.

A broad description of the system is as follows.

The SYSTEM comprises one or more processors configured to interact with a computer-readable medium in order to perform operations. The processors and databases making up the system can be networked, and preferably one or more cloud providers are used.

The SYSTEM comprises a Merchant Shopping Cart subsystem and the CARS subsystem. Interacting with the SYSTEM are a tax calculation module and payment authorization modules involving preferably separate payment processors involving the same payment method. There may be multiple Merchant Shopping Cart subsystems under the control of respective merchants which can interact with the same CARS subsystem. The SYSTEM is adaptable so multiple merchants and multiple tax authorities can participate. Merchant refers to an entity selling goods or services to a customer. Tax authority means that part of a State government responsible for collection of taxes.

The Merchant Shopping Cart subsystem can be either: i) a call center where orders are taken by phone; ii) an on-line retail website; iii) mobile applications on portable communication devices; or, iv) any combination thereof. The Merchant Shopping Cart subsystem is wholly owned and operated by the merchant or their software provider but includes modifications to communicate with the CARS subsystem. Customers will place goods or services of interest into the Merchant's electronic shopping cart. Information regarding the products or services, quantity and purchase price will be transmitted to a tax calculating service and will receive from the service the amount of tax due. The tax calculating service is usually operated by a third party although large retailers may perform this service in-house. The customer will be advised of the purchase price, shipping cost and tax to be paid. If the consumer purchases the products or services, the merchant is paid for the total purchase price plus any shipping charges and associated, non-tax fees by the Payment Source which is typically the card-issuing bank of or the financial institution behind the payment method used through the services of its Merchant Payment Processor. The merchant also transmits information regarding the purchase and the tax due to the CARS subsystem which is operated by an entity authorized by each respective tax authority to collect tax revenues due on customer purchases from the Payment Source. As used herein, merchant or retailer refer to a seller of goods or services to a customer.

The CARS subsystem provides one or more databases for information received from participating merchants and information regarding the transactions and the tax revenue received. CARS thereby provides a mechanism for reporting and possible audit tracking. CARS receives information regarding each consumer purchase and the tax due which is stored in one or more databases. The CARS subsystem is operated by an entity authorized by the respective tax authority to collect tax revenues due as a result of customer purchases. For example, if the State of Utah enters into an agreement with the operator of CARS for the collection of taxes, CARS can use the information received from the merchant, and charge the consumer's payment method for the tax due. The revenue received would be deposited into a separate revenue account for the Utah Tax Authority. As requested by the Utah Tax Authority, the tax revenue can be transferred to an account owned by the tax authority on any time interval.

The CARS subsystem can generate reports and collected revenue can be remitted per the guidelines of each respective State tax authority participating with the SYSTEM. The Tax Aggregator engine will be described later which permits the handling of refunds without the involvement of a State tax authority. Aggregated/summarized reports can be created without customer-identifiable information being accessible unless a system audit so requires.

One embodiment of the CARS subsystem comprises one or more processors configured to interact with a computer-readable medium to perform operations for collection of use tax revenue for participating state tax authorities from the purchase by a customer of goods or services from a website operated by a participating merchant, comprising the steps of:

maintaining at least one database for storing transactional records received from participating merchants for each customer order, including the identification of the participating tax authority to be paid and the tax due, and customer payment method;

maintaining at least one tax revenue account for each participating tax authority for receipt of funds directly from an account disbursement center;

receiving transactional records, the tax authority to be paid and the tax due, and payment method information from an electronic shopping cart of a participating merchant after a customer order has been fulfilled by said participating merchant;

charging the payment method the said tax due and depositing the tax revenue into a respective tax revenue account for the participating state tax authority; and,

periodically transferring the tax revenue from a respective tax revenue account to the respective tax authority.

An advantage of the SYSTEM over those in the prior art is that the merchant is relieved of its obligations for reporting, collection and remittance of tax revenue to the appropriate government tax authority.

Distinguishing features of the SYSTEM are:

1. Real-time tax collection in which a tax aggregation service, or a third party designated by the state's tax authority, receives the tax revenue directly from the customer's choice of payment method such as credit/debit cards.

2. Transparent consumer experience: Consumers will see almost no change to their shopping experience. The only visible difference would be the separation of the product and tax payments on their payment source i.e., credit card statement, and preferably a confirmation preferably by either text message or e-mail of payment generated from the CARS subsystem.

3. Initial auditing capable without the involvement of retailers: Various analyses of different aspects of the system can flag potential tax cheats, potential system failures and bottlenecks, and hacking attempts without merchant involvement.

4. Coverage for all purchases: The SYSTEM is capable of handling transactions related to physical goods, services, as well as digital goods with the same backbone infrastructure using the CARS subsystem. Point-of-sale transactions can also be handled by the SYSTEM.

Thus, one embodiment of the system can comprise one or more processors configured to interact with one or more computer-readable medium in order to perform operations comprising:

calculating, in relation to a purchase transaction, one or more tax amounts associated with said purchase transaction;

obtaining, in relation to the payment source, a first authorization for the price of the purchase transaction from a first payment processor; and a second authorization for the one or more tax amounts from a second payment processor and, subsequent to obtaining said first authorization, settling said first authorization in favor of a first account, and, subsequent to obtaining said second authorization, settling said second authorization in favor of a second account that is different than the first account. The second authorization is separate from the first authorization. The first authorization is from the Merchant Payment Processor and the second authorization is from the Participating Tax Authority Payment Processor.

The Payment Source is defined as the financial institution that pays the recipients of requested funds. In the case of credit cards, it is the card-issuing bank, which remits the funds to the merchant's bank first and bills the cardholder at the end of the billing cycle. In the case of debit cards or direct ACH debit, it is the bank which holds the customer account and debits the account for the funds being transmitted. In the case of electronic money services such as PayPal®, it is the financial intermediary (e.g., PayPal itself) that handles the transactions. Other money alternatives such as BitCoins, money-substitutes such as gift cards, and electronic wallet services such as Google Wallet are also considered to be Payment Sources applicable to interaction with the SYSTEM. The Payment Source which pays the merchant also pays the amount of tax due on the same customer transaction to CARS.

As stated earlier, the SYSTEM can further comprise an accounting method by which digital goods can be tracked by whether or not taxes have been paid and whether a retailer or merchant is authorized to sell certain items by their original manufacturers or distributors. Participation by state tax authorities in the SYSTEM can utilize tax collection as part of a solution to fight copyright piracy and counterfeiting.

Whether a digital good is properly sourced may not, by itself, be of interest to tax authorities, but potential tax revenue going uncollected should be of interest. For this methodology to function correctly, each distributor of digital goods would be required to register with the government and each digital good being distributed would need to be respectively stamped and recorded into a database such as within the CARS subsystem. With digital goods requiring a stamp/recordation, any transaction involving digital goods not having the required stamp/recordation would be flagged by the CARS subsystem and the merchant could be readily identified and prosecuted.

The SYSTEM described herein necessitates a means of record-keeping, which allows all concerned parties to verify the sales volume of each particular digital good. This means digital goods retailers cannot underreport sales information to the content owners (e.g., the record companies) of their licensing fees, and content owners cannot underreport royalties to the content creators (e.g., the musicians). This transparency provided by the SYSTEM will enhance accurate reporting to all concerned parties.

Accordingly, in addition to the four features presented earlier for sales/use tax collection, the following additional feature is included for monitoring on-line sales of digital goods:

5. Identification of individual digital goods sold: Each digital good sold will have a unique identifier, added to and maintained within an expanded version of CARS. Access to CARS by tax authorities will permit identification and tracking of illegal distribution. The transaction data and the unique identification system of individual files allow the identification of the original purchaser of the digital good and hence can facilitate the investigation into the illegal distribution of the said digital good.

### BRIEF DESCRIPTIONS OF THE DRAWINGS

FIG. 1 provides general overview of SYSTEM 100 which comprises a Merchant Shopping Cart subsystem, and a Charging, Archival, and Reporting System (CARS) subsystem;

FIG. 2 is a flow diagram illustrating a process by which sales transactions is managed and tax revenue is collected;

FIG. 3 illustrates the interaction of Merchant Shopping Cart subsystem with other processes;

FIG. 4 illustrates the interaction of the Tax Calculation Service with the Merchant Shopping Cart subsystem;

FIG. 5 illustrates the interaction of the Charging, Archival, and Reporting subsystem; and,

FIG. 6 illustrates a system view of how a customer is charged for an item purchase and tax with separate distribution streams for the merchant and tax authority.

### DETAILED DESCRIPTION OF THE INVENTION

In the description that follows, certain embodiments and/or arrangements are described with reference to acts and symbolic representations of operations that are performed by one or more devices. As such, it will be understood that such acts and operations, which are at times referred to as being computer-executed or computer-implemented, include the manipulation by one or more processors of electrical signals representing data in a structured form. This manipulation transforms the data and/or maintains them at locations in the memory system of the machine/computing device, which reconfigures and/or otherwise alters the operation of the system in a manner understood by those skilled in the art. The data structures in which data are maintained are physical locations of the memory that have particular properties defined by the format of the data. However, while an embodiment is being described in the foregoing context, it is not meant to provide architectural limitations to the manner in which different embodiments can be implemented. The different illustrative embodiments can be implemented in a system including components in addition to or in place of those illustrated herein. Other components can be varied from the illustrative examples shown. The different embodiments can be implemented using any hardware device or system capable of running program code. In another illustrative example, one or more of the systems described herein can take the form of a hardware unit that has circuits that are manufactured or configured for a particular use. This type of hardware can perform operations without needing program code to be loaded into a memory from a computer readable storage device to be configured to perform the operations.

Described herein are various illustrations showing broad aspects of various processing methods in accordance with at least one embodiment disclosed herein. It should be appreciated that several of the logical operations described herein are implemented (1) as a sequence of computer implemented acts or program modules running on one or more machines and/or (2) as interconnected machine logic circuits or circuit modules within the system(s) described herein. The implementation is a matter of choice dependent on the requirements of the device (e.g., size, energy, consumption, performance, etc.). Accordingly, the logical operations described herein are referred to variously as operations, steps, structural devices, acts, or modules. As referenced above, several of these operations, steps, structural devices, acts and modules can be implemented in software, in firmware, in special purpose digital logic, and any combination thereof. It should also be appreciated that more or fewer operations can be performed than shown in the figures and described herein.

The SYSTEM comprises the following subsystems:

a. Merchant Shopping Cart (MSC) subsystem. In the case of open-source shopping carts, the CARS operator will develop modifications and submit to the software provider for inclusion in future releases. In case where the software providers do not want the CARS operator's direct involvement, the system operator will provide the Application Programming Interface (API), a Software Development Kit (SDK), or any other items and support needed so their system can comply with the software provider's standards and protocol.

b. Charging, Archival, and Reporting System (CARS) subsystem is preferably a cloud-based subsystem for tax payments and maintenance of transactional records. CARS will initiate the tax payment charging process, aggregate the tax revenue collected from the Payment Source handling respective customer purchases, and remit and report to the participating state tax authorities per their requirements. The records will be archived securely per the retention period required.

The following interact with the SYSTEM:

i. Tax Calculating Service which as earlier described, provides the Merchant Shopping Cart subsystem with the tax due amount on the goods or services included in the electronic shopping cart.

ii. Merchant Payment Processor. This is a third party appointed by a merchant to handle certain payment methods such as, but not limited to, credit cards, debit cards, and electronic money such as PayPal®.

iii. Tax Authority Payment Processor. This is a third party appointed by each participating tax authority to handle certain payment methods such as, but not limited to, credit cards, debit cards, gift cards, virtual currencies such as BitCoin, electronic money such as PayPal®, and electronic wallet services such as Google Wallet. Each Tax Authority may nominate their own payment processor or use the default payment processor designated by the CARS operator.

iv. Participating Tax Authority. A State Tax Authority which participates in the SYSTEM. For example, the State of Utah may participate in the SYSTEM by authorizing CARS to accept tax payments from a designated Tax Authority Payment Processor. CARS would accept the funds in a trust or escrow account on behalf of the State and forward the revenue as instructed.

A Tax Calculating Service suitable for interacting with the SYSTEM would preferably comprise the following Internal Reference Databases: 1) the Tax Jurisdiction and Rates Database (TJRDB); 2) the Master Taxability Matrix Database (MTMDB); and, 3) the Retailers' Database (RDB). In addition, the Tax Calculating Service will store in a respective database for each merchant, product characteristics of each merchant.

1. The Tax Jurisdiction and Rates Database (TJRDB) 310 matches a ZIP+4 code to the smallest tax jurisdiction, which is generally the city. From there the state and county jurisdictions can be determined. The variables will include but are not limited to:

Jurisdiction ID. A unique ID for each jurisdiction possible, even if the jurisdiction currently does not tax at the city and/or county levels. Preferably, JIP will be the combined Federal Information Processing Standards (FIPS) of state, county, and places such as “State FIPS”+“County FIPS”+“Place FIPS” which will be 10 characters in length. This protocol permits easy adjustment of jurisdiction boundaries if needed.

State—The State of the tax jurisdiction

Jurisdiction Description—This can be displayed on the check-out screen and printable invoice if enabled by the retailer

Total tax rate (TTR). This is the total sales/use tax of the particular jurisdiction. The rate is the sum of the state tax base rate, plus applicable local rates (county and city), plus additional levies but levies preferably are generally lumped into one of the three levels (state, county, or city). TTR will not include any state-wide product-specific add-on taxes. Instead, add-on taxes would be included in the PTR of the MTMB described below.

2. The Master Taxability Matrix Database (MTMDB) 320 comprises data supplied by the participating states' tax authorities and includes the following variables:

Taxability Matrix Reference Number (TMR), which is already assigned by the Streamlined Sales Tax Government Board (SSTGB), the convener and organizer of the multi-state Streamlined Sales and Use Tax Agreement (SSUTA), and visible in its taxability matrix documents. For states with additional tax exemption rules, the system operator can create additional reference numbers to accommodate those items.

Product Tax Rate (PTR). A variable for each taxing jurisdiction indicating the tax ratio in that jurisdiction. For instance, “100” means the item is taxed at the full tax rate, “0” means the item is not taxed at all, and “50” means the product is taxed at half of the full tax rate (or that half of the product price is taxed at the regular rate). The MTMB will store the variables for jurisdictions whose data are in the system, but only transactions for participating states will see the tax calculations and only those states will receive remittance. The PTR can exceed “100” if there's a special product-specific ad valorem tax that's normally tagged onto the sales tax (e.g. gasoline taxes).

Provisions can be incorporated into the PTR for supplemental unit taxes or fees such as California's recycling fee for mercury lamps (found in most LCD screens), etc.

3. All participating retailers or merchants in the SYSTEM are included in a master Retailers' Database (RDB) 330. All retailers will register with the Streamlined Sales Tax Governing Board (SSTGB) through a central registration system that all participating tax authorities access. Each retailer will be given an identification number which is accepted by all tax jurisdictions as the unique identifier for that retailer. The RDB will contain basic information about the retailer, such as name, address, controlling jurisdiction (generally where their company is domiciled), EIN/TIN, contact information, contact person or responsible party, etc. There will also be a Boolean variable that indicates whether this retailer sells possible tax-exempt items or services. If this variable is set to be false, then the Tax Calculation Service will apply the standard tax rate to all items and skip the Product Characteristics Database (PCDB) lookup process (see below for more details).

### Retailers' Product Characteristics Databases

Retailers will be given an opportunity to create their Product Characteristics Database (PCDB 340) which is unique for each retailer or merchant. This database enables a retailer to match their product/item codes to a line in the SSUTA taxability matrix (TM) so the item may receive different tax treatment in some states. The PCDB comprises at least the following information:

Product ID (PID) proprietary to each retailer, and which is preferably the retailer SKU identifiers;

Product Description for each Product ID so each retailer can respectively review information related to their products to ensure accuracy; and,

Taxability Matrix Reference Number (TMR).

At the start of the PCDB creation process, the retailer will be shown a list of product categories with potential tax exemption issues. If the retailer indicates that it has no products which fall into those categories, then PCDB need not be created. Preferably, the Tax Calculating Service will record that retailer as fully taxable and skip the product tax exemption lookup process. This should be applicable for most retailers and thus speed up the tax determination process.

The following is a non-exhaustive list of categories that could have tax exemption issues which may require PCDB creation: clothing, custom (not pre-written/off-the-shelf) software or software maintenance services; digital products (e.g., music, books, or movies for download); food products; drugs/medicine; medical equipment; mobility enhancement equipment; and, telecommunications services.

If the retailer does not create the PCDB or an item is not included in the PCDB, the system will assume the product is taxable in all jurisdictions at the normal tax rate. The Tax Calculating Service operator should communicate with the retailer to include PIDs for items that may have taxability concerns. Otherwise, the customers of such a retailer may be taxed even though some of the items are tax-exempt.

For states not participating in Streamlined Sales and Use Tax Agreement (SSUTA), the Tax Calculating Service operator will assist with creating a reference file so their taxability matrix can match SSUTA's specifications as is possible.

Some states have exemption rules not covered by the SSUTA taxability matrix template. Those will be handled by supplemental reference numbers and related programming.

### Methods of Use of the SYSTEM

The SYSTEM can be designed to handle physical goods & services differently from digital goods. Each is described separately below despite the similarity in the process.

With the respective databases described earlier, the methodology would proceed as follows.

Brief Overview of SYSTEM (100)

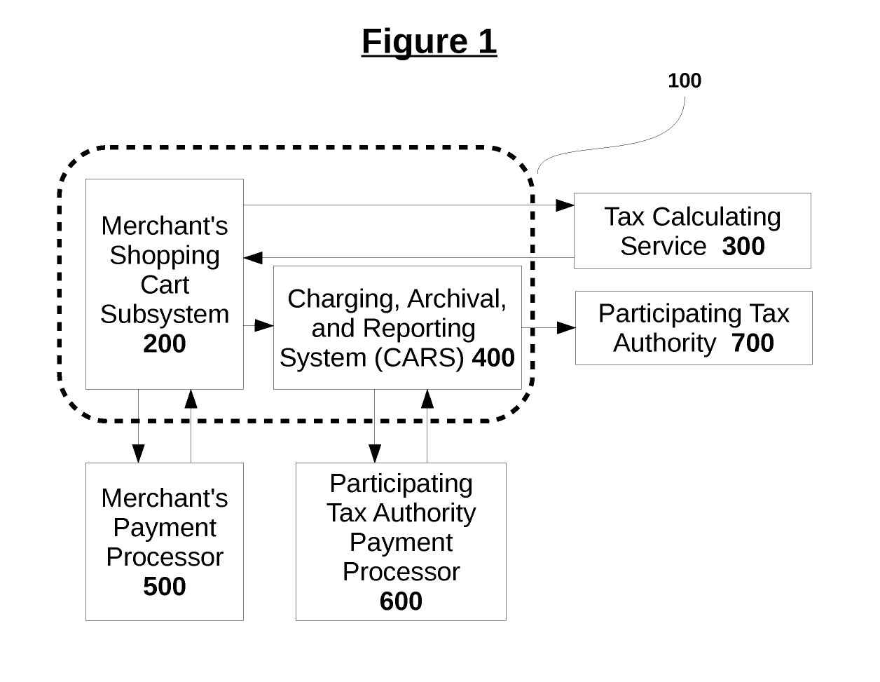

FIG. 1 provides general overview of SYSTEM 100 which comprises a Merchant Shopping Cart subsystem 200, and a Charging, Archival, and Reporting System (CARS) subsystem 400. SYSTEM 100 is designed to permit tax authorities to receive use tax revenue from merchants selling goods or services to customers in different state jurisdictions. FIG. 1 also illustrates the interaction between the subsystems of SYSTEM 100 and a Tax Calculating Service 300, and a merchant payment processor 500, a participating tax authority payment processor 600 and the participating tax authority 700. One or more tax authorities may participate with SYSTEM 100 and it is therefore possible that there will be a separate payment processor 600 for each participating tax authority 700. Similarly, one or more merchants may wish to participate in SYSTEM 100 and thus respective Merchant Shopping Cart Subsystems for each participating merchant would be part of SYSTEM 100.

Brief Overview of the Merchant Shopping Cart (MSC) subsystem (200)

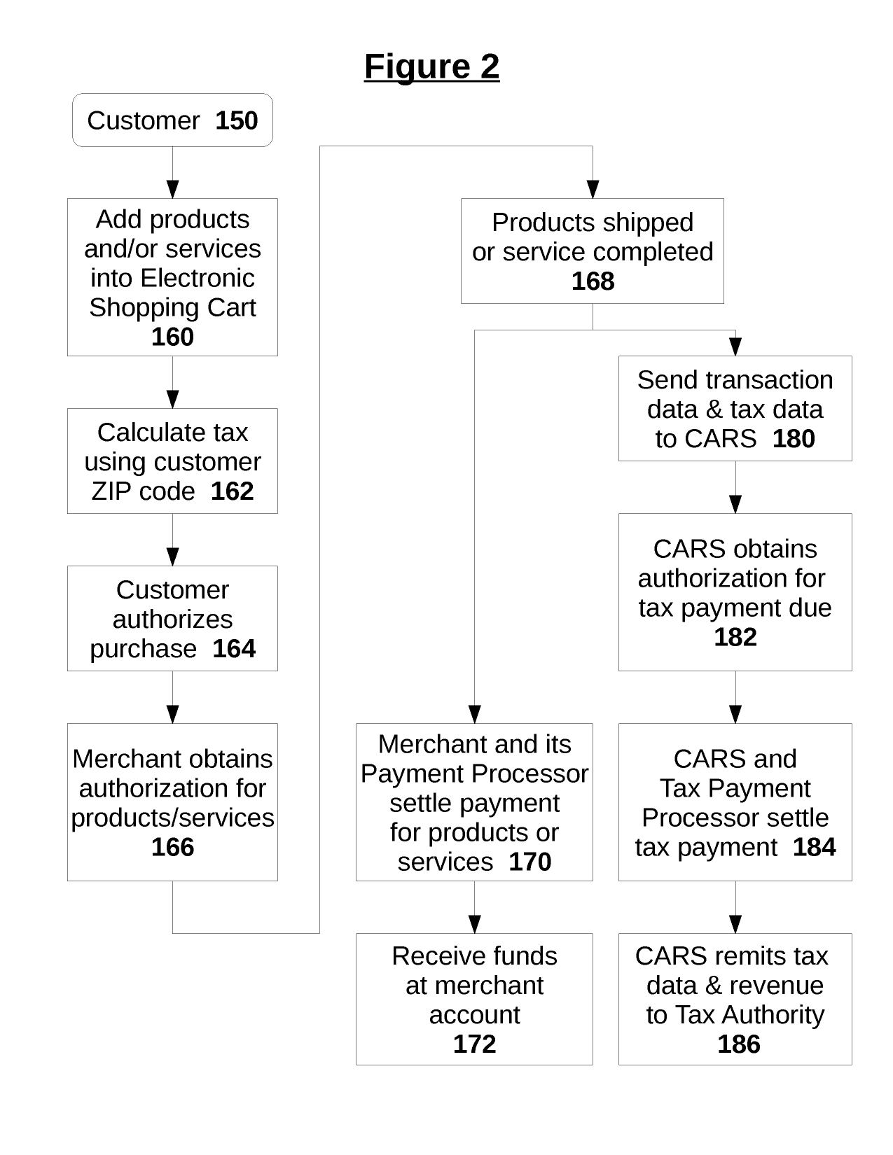

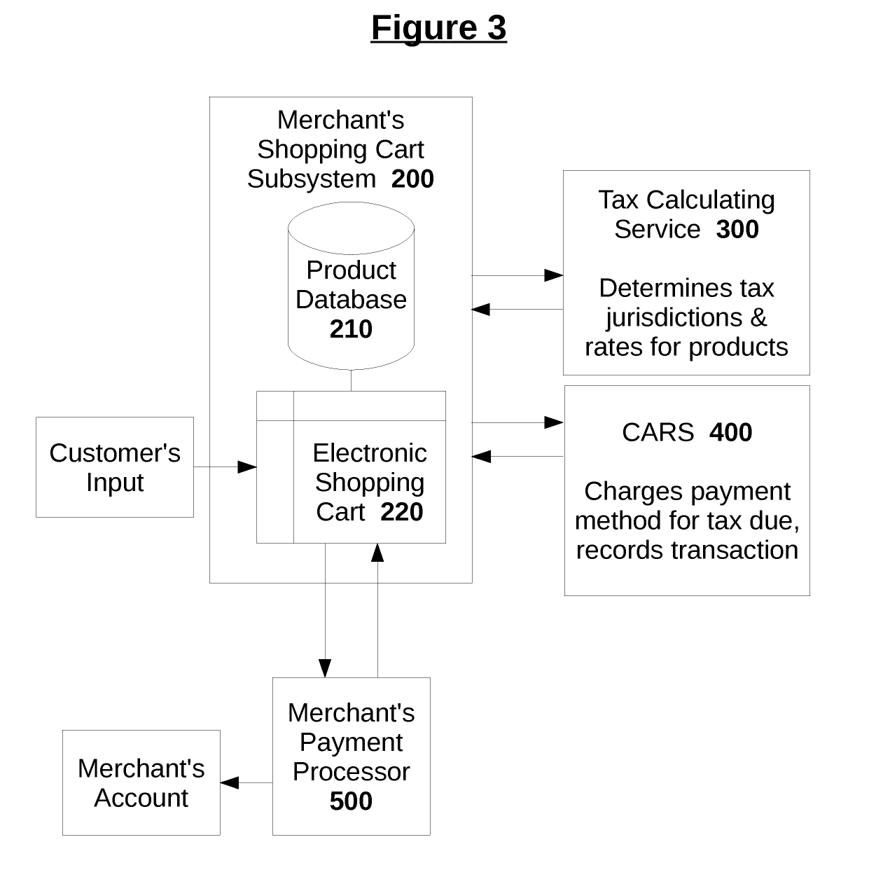

FIG. 2 provides a sequence of steps and FIG. 3 provides how the MSC 200 interacts with other processes. MSC 200 comprises at least one product database 210 which contains product and pricing information. It is linked with the electronic shopping cart 220. Customers 150 will visit a merchant's website or application using a computer, smartphone or other communication device having wired or wireless Internet or network connectivity and shop on the merchant's website or mobile application and input items of interest at block 160 into the electronic shopping cart. Alternatively, customers can call the merchant provided customer service number and speak to a person who would have access to the electronic shopping cart. Items of interest will be placed into the merchant's shopping cart per the direction of the customer. When desiring to purchase the goods, the customer will initiate the check-out process. The check-out process will include information provided by the customer either: a) as part of an earlier transaction and stored within the Merchant Shopping Cart subsystem 200 or, b) provided by the customer at check-out. This information will include the shipping ZIP code before an order is placed. At this stage before an order is placed, electronic shopping cart 220 transmits information to Tax Calculating Service 300. The information includes the following: the Retailer ID (RID); Product ID(s); Sales ID (SID), and a temporary ID which enables the electronic shopping cart 220 to properly direct the information to be associated with this particular transaction; and, the shipping ZIP code (ZIP+4 if possible). If the shipping ZIP code is not available, then billing ZIP code will be used. This information is required even if the transaction will be paid using a non-credit/debit card payment system such as PayPal®. The tax calculated is provided as block 162.

At this stage, the customer can cancel the order, revise the order, or proceed to place the order.

If the customer decides to revise the order, the revised items and quantities along with the same information described earlier is again transmitted to the Tax Calculating Service 300.

When the customer authorized the purchase of the items in the electronic shopping cart 164, an authorization request for the purchase price of the goods including shipping charges if any, is transmitted to the Merchant Payment Processor (MPP) and an authorization is obtained 166. Once the items are shipped by the merchant or services completed 168, the merchant and the MPP settle the purchase transaction 170 and the merchant receives funds for the purchase transaction into its merchant account 172. At the same time as the MPP is settling the approved purchase transaction, electronic shopping cart 220 transmits data regarding the order to CARS 180. CARS then transmits an authorization request for the tax due amount on the purchase price to Tax Authority Payment Processor 182 and request the tax amount due be settled 184. CARS, acting as an escrow for the participating tax authority, holds all tax revenue received in an account held in trust for the participating tax authority which the customer owes tax from the purchase from the merchant. CARS then electronically deposits the revenue to the tax authority account on a periodic basis as determined by the tax authority 186.

Alternatively, if the retailer desires to provide the estimated tax as a service to the customer but not wish to transmit information to CARS for subsequent tax collection, the retailer can limit his participation in the SYSTEM and only transmit to Tax Calculating Service 300 the quantity and price for each product in the shopping cart and ZIP code. With this information, the Tax Calculating Service can calculate the total tax and transmit back to shopping cart engine 220 only for the purpose of transmitting this information to the customer.

Preferably, all data transmissions will be encrypted to protect the privacy of the retailers and consumers.

The electronic shopping cart 220 can be designed to optionally show the customer the taxing jurisdiction and the final tax amount to be charged. This can be shown as a separate line item (e.g., a dynamically defined text string) and therefore not impact the existing payment gateway process.

In the event the Tax Calculating Service 300 is down or unable to provide the tax jurisdiction, tax rate, and total tax amount for any reason, the Merchant Shopping Cart subsystem 200 can queue the query for later processing and preferably display a message on the check-out screen and invoice such as: “The tax amount cannot be determined at this time. Please assume your products may be taxed up to the maximum sales tax rate of your local tax jurisdiction.” In any event, the SYSTEM is designed to not hinder the retailer's transaction processing.

When electronic shopping cart 220 charges the consumer's payment method, which generally happens at the time of shipping, it will create two separate data submissions besides the normal merchant processing which covers the purchase price and any shipping charges.

The first is the detailed transaction data to CARS. This will preferably comprise the following data:
Retailer ID;
Transaction ID, a unique ID for each transaction created by the retailer's shopping cart system;
Jurisdiction ID—for tax allocation;
Product ID;
Product Tax Rate (PTRs—0 to 100+), Quantity, and Price of each distinct item in the order;
The individual items' taxes and total tax amount charged;
Payment and associated information—name of customer, billing address, credit card number or a substitute payment information identifier, CVC, etc.; and,
Purchaser and shipping information—name, contact e-mail, shipping address, etc.

A unique identifier for each and every transaction can be created by utilization of Retailer ID and Transaction ID.

The second data transmission is to the retailer's own merchant payment processor for the sale amount. To facilitate records reconciliation, the system operator will encourage the retailers to code the transaction ID into the information sent to its merchant payment processor so each transaction can be identified on the consumer's payment method statement to help consumers match the purchase with the tax charged.

Brief Overview of the Tax Calculating Service (300)

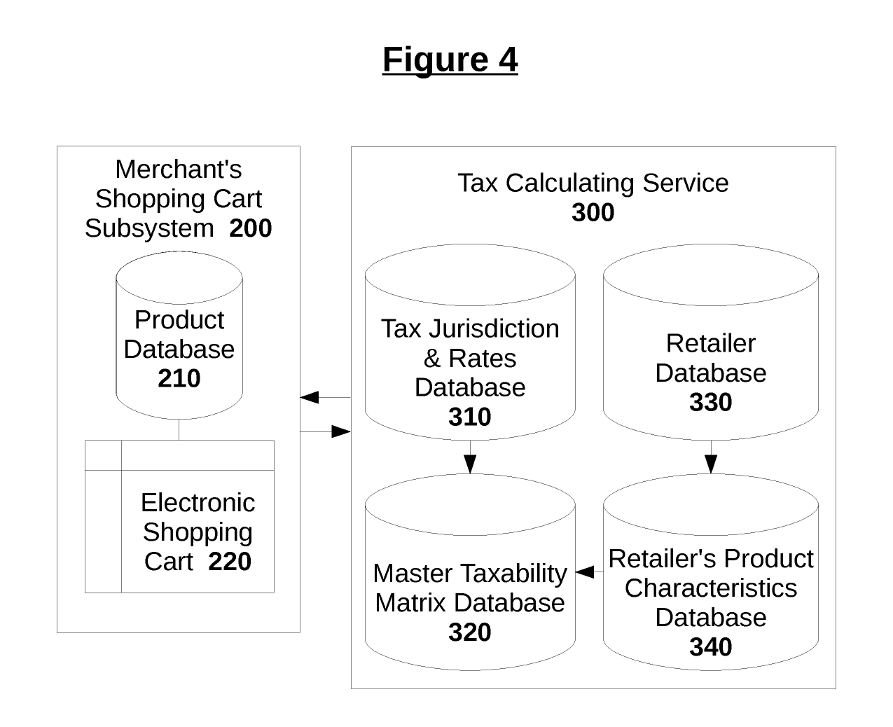

FIG. 4 provides a general overview of how the Tax Calculating Service 300 functions as part of SYSTEM 100. The Tax Calculating Service 300 uses the shipping ZIP+4 code received from the Merchant Shopping Cart subsystem 200 to determine the tax jurisdiction. If that is not possible or applicable, subsystem 300 will use of the 5-digit billing ZIP code associated with the payment method. Preferably, each participating state tax authority is responsible for proper allocation of collected local taxes and would have their own internal formula to allocate questionable funds.

The Tax Calculating Service 300 receives transmitted data from the shopping cart engine 220 which contains price, quantity and ZIP code information as previously described.

As illustrated in FIG. 4, Tax Calculating Service 300 utilizes information received from MSC subsystem 200 to calculate the tax and thereafter transmits to the tax calculations to subsystem 200 based on the following information: Reference ID, to ensure the data is sent to the proper merchant; Jurisdiction ID; Sales ID; Tax Jurisdiction Description (e.g., “Salt Lake City, Utah”); Product ID and Product Tax Rate for each item in the shopping cart; the Total Tax Amount and optionally, each product's tax amount (this is dependent upon the merchant's shopping cart's capabilities).

Brief Overview of CARS (400)

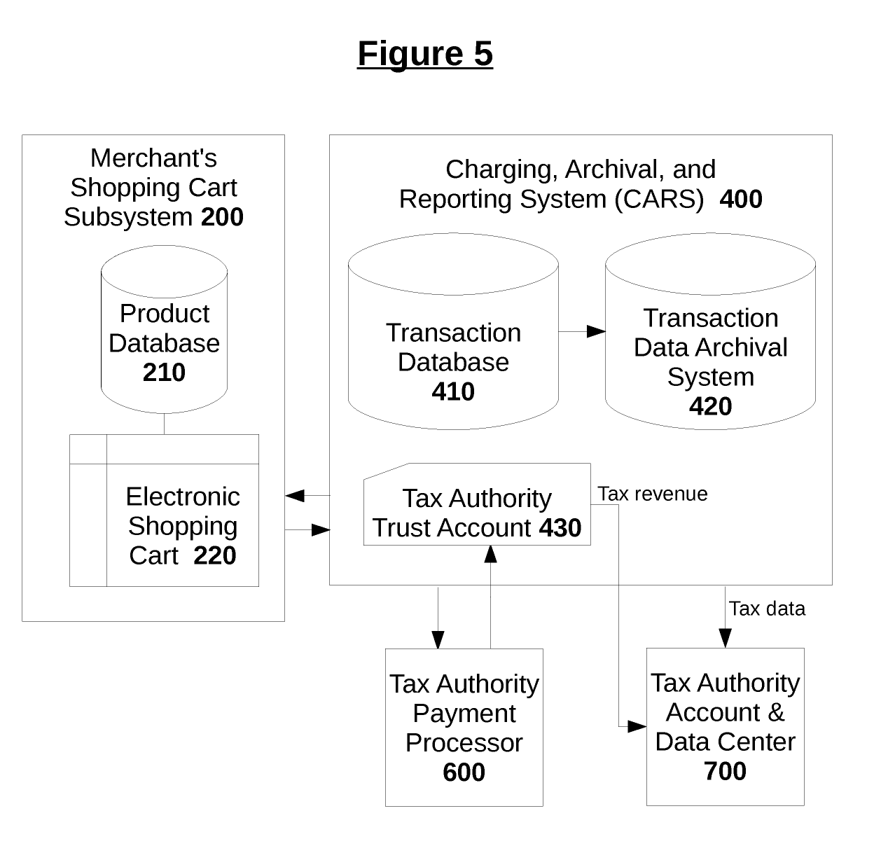

FIG. 5 provides a general overview of how the Charging, Archival, and Reporting System (CARS) 400 functions as part of SYSTEM 100. CARS receives information from shopping cart subsystem 200 when a customer places an order as previously described earlier. CARS 400 comprises a at least one database for storage of merchant transaction information for every customer order placed and at least one respective trust accounts for each tax authority participating in the SYSTEM.

As CARS receives customer order information from the merchant shopping cart subsystem 200, the information is held until a subsequent notice is received from subsystem 200 informing that the customer order is being shipped and the retailer is settling for the due amount regarding purchase price of the goods and any associated shipping charges. Once this notice is received, CARS will then charge the customer's card using a preferred service center and deposit the tax revenue into the applicable tax authority trust account.

It is probable that a tax authority will want the CARS operator to use a particular service center for processing credit card payments and thus it is possible that each participating tax authority will request the use of different payment processors 600. In any case, the funds received from the processors will be deposited into the appropriate tax authority account 430 which CARS manages in trust. Each tax authority will periodically request that the tax revenues held in trust be transferred to the tax authority along with the associated data 700.

CARS can generate reports for retailers and states. The following security features address privacy concerns:

Transaction records stored in CARS's databases 410 and 420 are preferably protected from unauthorized access. All access must be authorized, monitored, and recorded. Records must be read-only and any change in the data, whether intentional or caused by equipment failure must be identified. Preferably, CARS is designed so that the CARS operator must not have access to individual transactional data because without such security in place, retailers will resist participating in the SYSTEM.

The retailer, upon request from a tax authority, can provide authorization to the CARS operator for the tax authority to have access to its records in CARS so an audit can be conducted without burdening the retailer.

If suspicious activities are discovered in the audit (e.g., CARS recording far more order placements but not final charges, or unusual high rates of Tax Calculating Service queries but few final transactions), then a full audit may be requested to determine if a problem exists or if deliberate hindrance of the tax collection process is occurring. Missing records in CARS may indicate a connectivity problem. High volume of Tax Calculating Service queries but few CARS and tax transactions or missing tax payments that match CARS records may indicate tax evasion.

Because CARS operates a trust account for each participating tax authority 430, it can issue refunds through a negative charge on the payment method. By way of example, if a product is returned to the retailer for which a refund is due to the customer, merchant shopping cart subsystem 200 will issue a credit to the customer on the purchase price and will also transmit to CARS a request containing the sales ID and type of goods and quantity returned. CARS will compare the request against the record in its database and calculate the tax portion due to be credited back to the customer. The credited portion will be recorded as a negative charge against the revenue existing in the trust account. In this way, tax authorities will not have to be involved with refunding use tax for returned items. Since the taxes are aggregated into respective accounts or sub-accounts for the participating tax authorities prior to remittance to the states, refunds will be debited from the trust accounts and not directly from states' accounts.

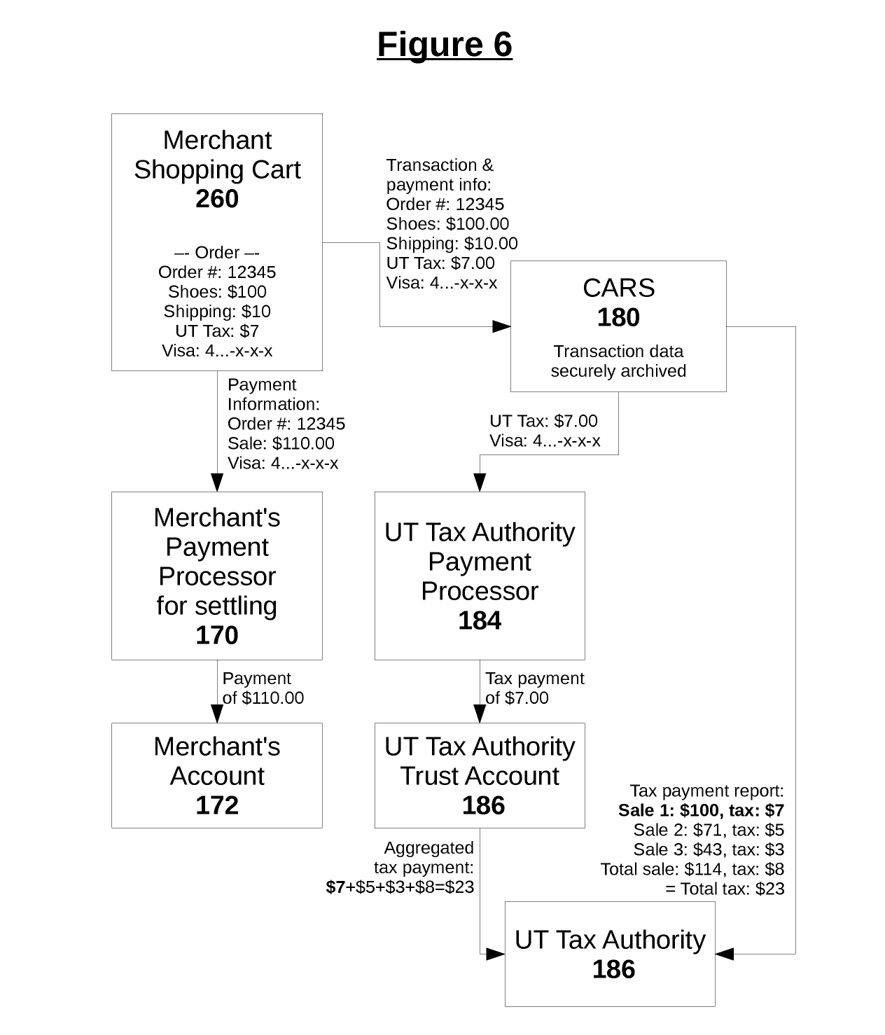

An example of the purchase process is provided in FIG. 6. At block 260, the customer has populated the electronic shopping cart with items totaling $100.00 and has provided a ZIP code which is used to determine the ZIP code is for a Utah address and the amount of tax due on a Utah address is $7.00. In addition, shipping charges were also calculated. All these procedures have been previously discussed and are presented as block 260.

Upon the customer proceeding to purchase the items in the electronic shopping cart, payment information including the order number 12345, the $110.00 sale value ($100.00 purchase price+$10.00 shipping charges), and payment source information (such as a credit card) are forwarded to the Merchant's Payment Processor 170 and the $110.00 is thereafter deposited into the Merchant's account at block 172. At the same time as payment information is being transmitted to the Merchant's Payment Processor, information is also being transmitted to CARS 180. This information includes the Order Number 12345, $100.00 purchase price, the amount of tax due to the Utah tax authority $7.00 and the customer's payment source information. CARS then obtains an authorization and settles the $7.00 tax due from the payment processor directed to be used by the Utah Tax Authority at block 184 and the $7.00 is deposited into a trust account operated by the CARS operator on behalf of the State of Utah Tax Authority at block 186. Besides receiving the $7.00 tax payment, Utah Tax Authority Trust Account aggregates tax payments from not only other customers of the same merchant, but also customers of other merchants who are participating in the SYSTEM and using the same CARS operator. In the example illustrated in FIG. 6, tax revenue is aggregated from 4 transactions totaling $23.00 and at a time designated by the Utah Tax Authority, the aggregated tax amount of $23.00 is transferred from the trust account into an account owned and operated by the Utah Tax Authority at block 186. Additionally, a tax report containing information regarding the transfer is also transmitted by CARS 180 to the Utah Tax Authority 186. It is also to be noted that other Tax Authorities can participate in the SYSTEM at the same time so that the same CARS operator can handle trust accounts for more than one Tax Authority and as a consequence, be communicating with respective Payment Processors for settling tax revenue due.

### Digital Goods

As described earlier in the Summary of Invention, CARS can be modified to address piracy and counterfeiting of digital goods.

To implement this method of protection, the government requires: 1) identifying whether a digital good has been taxed; and, 2) the ability to identify the source of an unauthorized distribution, which could be by identifying an untaxed item or an item once taxed but that is being redistributed without taxes being paid for each re-distribution.

The SYSTEM can be implemented over time to eventually maximize tax enforceability.

Taxation can be imposed without either of the methods described below, but enforceability will be greatly reduced. Relying only on the threat of tax laws will likely have very limited impact because many violations will be difficult to prove in the court of law without use of the following technologies.

Digital Stamping (DS) is the first step in taxation verification. It indicates whether a digital good was initially sourced through an authorized channel and the proper tax was paid per government tax laws. The electronic stamp could be either: 1) a distributor-specific code whereby each distributor possesses a unique code which would allow for limited tracing back to the distributor; or, 2) a universal code for proving tax compliance but having no tracing capabilities; or, 3) a unique code in combination with the unique identifier to be discussed below.

The actual digital stamp will be encoded by the actual distributor of the digital good, most likely in the metadata portion of the digital file. The distributor could pre-encode the digital stamps so this will have no impact on delivery time. The retailer may not be the actual distributor and it is up to the retailer and distributor to negotiate the digital stamping and record-keeping responsibilities.

The exact digital stamp will be based on a pre-arranged algorithm to be determined by industry associations such as Metadata Working Group (MWG) and Moving Picture Experts Group (MPEG) in conjunction with an association of tax authorities such as the Streamlined Sales Tax Project (SSTP).

DS will be removed deliberately during a re-encoding process, generally done to reduce file size or create new content. DS is a certification of a “legitimate purchase” of “original content.” Any modification to the file will invalidate its “original content” status.

At this time, a playback device will play any file regardless of the presence of a DS. DS is not meant to be a DRM system that restricts playback. The lack of a DS in a digital file being distributed is cause for tax violation investigations but not a sufficient cause to render it unusable. Any entity that facilitates the distribution of content without the properly issued DS is at least an accomplice to tax evasion and thus prosecutable under existing tax laws. Intra-family distribution of legitimately purchased content should not be regulated nor prosecuted. This system is meant to stop widespread piracy by targeting intermediaries such as the torrent-hosting and torrent-searching sites.

Unique Identification (UID) is the second step in taxation verification. It is needed for auditing, tracking & tracing, and prosecution of violators. Without Unique IDs, it would be nearly impossible to identify the initial sources of illegal distribution.

Unique IDs can be generated by the distributor per pre-arranged algorithms that allow for easy identification of the original distributor, and allow for unique numbers to supplement that distributor identification. The unique numbers can refer to the actual initial sales transactions. Therefore, there should never be any duplicate Unique IDs.

The Unique ID can be part of the metadata or extensible metadata (compliant with the EMP standard) of the digital file being distributed. Modifications to existing playback software or devices are therefore not necessary.

Unique ID can supplement existing digital rights management systems (DRM) that some digital goods distributors already use to control distribution. DRMs are not very popular with consumers due to sometimes excessive restrictions. Most consumers feel that if they buy something, they should be able to share it within the family effortlessly, just like they can share a CD or DVD. With the implementation of digital goods taxation and Unique IDs, DRMs may not be necessary because intermediaries such as torrent-hosting and torrent-searching sites will become accomplices to tax evasion and be shut down. ISPs serving those sites will also be concerned about being labeled as accomplices and therefore refuse to carry their traffic. Without the intermediaries, large-scale piracy cannot exist.

The Unique ID must not be designed in such a way that the original purchaser can be easily identified without conducting an audit through CARS. Unique IDs are unique to the files, not the consumers. For instance, a portion of the Unique ID must not be a unique identifier of the initial purchaser. This is critical to privacy protection.

To avoid Unique ID circumvention via recoding, video encoding software can be mandated to preserve Unique IDs during the re-encoding process (generally done to reduce file size or to make a file playable on a certain device). The Unique ID should be inherited by any cropped, re-mixed, or slighted modified files. Multiple Unique IDs may exist for one file if the file is a mixture of multiple authorized files containing Unique IDs. These policies are to be determined by industry associations such as the MWG or MPEG.

To be effective, DSs, Unique IDs, and the item purchased/licensed need to be recorded by one or a few central databases operated by a third party, such as CARS. This would allow tax and copyright law enforcement agencies to conduct audits without requiring participation by the distributors, and content owners (e.g., entertainment companies or independent artists). The exact number of purchases can be identified and compared with the royalty payments received from the individual distributors. Royalty payments are critical to the livelihood of artists, performers, musicians, etc., and therefore critical to the well-being of the entertainment, software, and publishing industries.

Furthermore, the integrity of the DS and Unique ID can be better protected by embedding the hash value of the DS and Unique ID in the content portion of the digital file but in such a way that it does not impact the playback of the digital file. When the player detects an inconsistency between DS and Unique ID and their hash value, it can display a warning about the integrity of the digital file.

The final design of the DS, Unique ID, and the hashing scheme will have to be determined by applicable industry consortia so there's a universal standard and adoption strategy.

In the case of software, this system will supplement the existing product activation schemes. It will not replace any measure meant to limit the unauthorized installation of software.

### Legislation Approval

For the methodology described above to function to its fullest capability, legislation will be required to clarify how the SYSTEM+DS+Unique ID would be allowed to function and what laws would apply in case of violations. For example, digital goods distributors are required to register with the government in order to be issued a digital stamp code and/or be given the authorization to encode digital goods with the proper digital stamps. Then the following could be considered as tax evasion as well as potential underreporting of royalty payments:
An authorized distributor selling un-stamped digital goods
An unauthorized distributor selling either stamped or un-stamped digital goods
A individual sharing either stamped and un-stamped digital goods

The following could be considered as accomplices to tax evasion even though they may not be prosecutable by existing copyright laws:
A willing facilitator—a torrent search/hosting site, search engines that do not actively filter out such activities based on technical feasibility, etc.
An involuntary facilitator—any venue people use to publicize illegal/unauthorized downloads (e.g., Craig's List, discussion forums). Their legal liability may be limited by proper “acceptable use” policies, visible warnings, and other “good-faith” efforts.
Internet Service Providers (ISPs) and hosting companies of non-compliant intermediaries. ISPs can easily identify illegal activity based on pattern of traffic and thusly should not be able to claim ignorance about their customers' behavior.
Internet Service Providers (ISPs) and other common carriers to consumers. Ignoring legitimate cease-and-desist requests could now trigger costly and burdensome tax audits. This threat alone may eliminate the majority of illegal downloads and exchanges by cutting off the transmission mechanism.

Implementation of digital goods taxation can categorize facilitators as accomplices to tax evasion and effect a considerable portion of the anti-piracy objectives of this system. The use of digital stamping (DS) and unique identifiers (UID) will further enable enforcement, investigation, and prosecution of violators. Digital goods taxation can be imposed without any technical changes to the digital goods, but the impact on piracy and counterfeiting would be more limited. The SYSTEM, adapted to include the addition of digital stamps (DS) and unique identification (UID), would greatly enhance the enforcement of tax and copyright laws.

The SYSTEM+DS+Unique ID can be adapted to spot distributors of potential counterfeit goods or unlicensed distributors of genuine goods. The retailer registration may request information on whether a retailer is licensed to sell certain products by certain manufacturers. Algorithms may be implemented whereby the Tax Calculation Service and/or CARS can compare the product descriptions, definitions, and/or UPC codes against the retailer database and identify distributors of counterfeit products or potentially unlicensed distributors.

### Data Aggregation

CARS has the ability to archive transactional records of all sales of participating online retailers and most preferably, the most restrictive data security and privacy protection protocol should be utilized. A system such as the Casdex® SEC Rule 17a-4-compliant storage system will ensure that even the service provider cannot access the retailers' and customers' data without proper, explicit authority from the retailers and tax authorities. Data being transmitted to tax authorities will be anonymized and aggregated/summarized. Only with proper legal authority and request from the tax authorities will individual records be released for auditing purposes.

Even without access to privacy-sensitive individual records, CARS can greatly assist the government's need for data by creating certain reports to help it keep track of economic trends so its economy-stabilizing policies can be implemented with better, real-time data.

The same technology can be used to provide reports to retailers, content owners (e.g., the studios and record companies), and the content creators (e.g., the musicians and actors) so accounting of sales are transparent to all concerned parties. This will ensure the proper settlement of royalty and licensing payments among these parties.

### Customer Experience

Customers will notice minimal change in their shopping experience. The SYSTEM+DS+Unique ID is designed to minimize the change to customer experience. The most significant change will be to their payment method. Instead of having the product payment and the associated tax bundled in one charge, the customer payment source statement will have two charges for each online purchase.

The merchant will be encouraged to put the order ID on the credit charge. The tax charge will show the same order ID. This will help the customer reconcile their purchases.

It is to be understood that like numerals in the drawings represent like elements through the several figures, and that not all components and/or steps described and illustrated with reference to the figures are required for all embodiments or arrangements. It should also be understood that the embodiments, implementations, and/or arrangements disclosed herein can be incorporated as a software algorithm, application, program, module, or code residing in hardware, firmware and/or on a computer useable medium (including software modules and browser plug-ins) that can be executed in more than one processor comprising the SYSTEM to perform the functions and/or operations described herein.

Thus, illustrative embodiments and arrangements disclosed herein provide a computer implemented method, computer system, and computer program product for transaction processing. The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

We claim:

1. A method comprising:
providing an electronic shopping cart;
receiving customer-provided data into the electronic shopping cart in relation to a transaction;
calculating the total purchase price in relation to a transaction;
transmitting at least a portion of said customer-provided data to a tax calculation service for purposes of determining whether tax is owed to a participating tax authority and calculating any tax due in relation to the transaction;
receiving from said tax calculation service the tax due amount in relation to the transaction;
obtaining, in relation to a payment source, an authorization for the non-tax total purchase price in relation to a transaction;
thereafter, settling said authorization in favor of an account and,
transmitting at least a portion of said customer-provided data to a third party authorized to collect tax revenue on behalf of a participating tax authority.

2. The method of claim 1 in which the receiving step from said tax calculation service further includes the identity of the participating tax authority to which the tax due is owed.

3. The method of claim 2 in which said transmitting step includes the identity of the participating tax authority to which tax is owed.

4. The method of claim 1 in which said transmitting step includes the amount of tax due in relation to the authorization.

5. A method comprising:
providing an electronic shopping cart;
inputting customer-provided data into the electronic shopping cart in relation to a transaction;
calculating the total purchase price in relation to a transaction;
transmitting at least a portion of said customer-provided data to a tax calculation service for purposes of determining whether tax is owed to a participating tax authority and calculating any tax due in relation to the transaction;
receiving from said tax calculation service the tax due in relation to the transaction;
obtaining, in relation to a payment source, an authorization for the non-tax total purchase price in relation to a transaction;
transmitting at least a portion of said customer-provided data to a third party authorized to collect tax revenue on behalf of a participating tax authority; and,
thereafter, settling said authorization in favor of an account.

6. The method of claim 5 in which the receiving step from said tax calculation service further includes the identity of the participating tax authority to which the tax due is owed.

7. The method of claim 6 in which said transmitting step includes the identity of the participating tax authority to which tax is owed.

8. The method of claim 5 in which said transmitting step includes the tax due in relation to the authorization.

9. A system comprising one or more processors configured to interact with one or more computer-readable medium in order to perform operations comprising:
calculating, in relation to a purchase transaction, one or more tax amounts associated with said purchase transaction;
obtaining, in relation to a payment source: a) a first authorization for the price of the purchase transaction from a first payment processor; and, b) a second authorization for the one or more tax amounts from a second payment processor;
subsequent to obtaining said first authorization, settling said first authorization in favor of a first account; and,
subsequent to obtaining said second authorization, settling said second authorization in favor of a second account that is different than said first account.

10. The system of claim 9 in which said first payment processor is the same as said second payment processor.
